(19) United States
(12) Patent Application Publication
(10) Pub. No.: US 2009/0085552 A1
(43) Pub. Date: Apr. 2, 2009

(54) POWER MANAGEMENT USING DYNAMIC EMBEDDED POWER GATE DOMAINS

(76) Inventors: Olivier Franza, Boston, MA (US); Mondira Pant, Westborough, MA (US); Stefan Rusu, Sunnyvale, CA (US); Michael Zelikson, Haifa (IL)

Correspondence Address: INTEL CORPORATION;c/o INTELLEVATE, LLC, P.O. BOX 52050, MINNEAPOLIS, MN, 55402, US

(21) Appl. No.: 11/864,914

(22) Filed: Sep. 29, 2007

(51) Int. Cl. G06F 1/26

(52) U.S. Cl. 323/350

(57) ABSTRACT

In some embodiments of the invention, a processor with a power management scheme using dynamically switchable embedded power gates.

### BACKGROUND

The present invention relates to power management for integrated circuits such as microprocessors and is also applicable in consumer electronics, cell phones etc. where low-power is essential.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a diagram showing relative power consumption for different power states.

FIG. 2 is a diagram of a portion of an integrated circuit with dynamically supplied EPG domains in accordance with some embodiments.

FIG. 3 is a diagram of a portion of a test block EPG domain in accordance with some embodiments.

FIG. 4 is a partial die circuit layout for the test circuitry of FIG. 3.

### DETAILED DESCRIPTION

Disclosed herein is a power delivery scheme using embedded power gates (EPGs) that are able to effectively counter dynamic voltage droops, caused by capacitor switching noise. As disclosed in co-pending U.S. patent application entitled: “EMBEDDED POWER GATING,” filed concurrently with the present application and incorporated by reference herein, the use of EPGs allow for the use of local static power domains. With the use of package capacitors having sufficiently low inductance paths, they may be quickly switched thereby enhancing use and operation of multiple local power domains.

As used herein, power gating refers to controlling the voltage supplied to the transistors in a region (or sub-region) of an integrated circuit by intercepting a supply path, from a voltage regulator or other power gate supplying power to the region, in order to reduce or substantially remove the voltage supplied to the region. The supply may be wholly removed (or collapsed) or it may be reduced to save power but retain state, e.g., in a so-called sleep mode.

As taught in the previously referenced co-pending application, embedded power gates (EPGs) are on-die transistors that are disposed proximal to or within a circuit region making up the EPG domain. In some embodiments, the use of EPGs can provide for explicit control of voltage supplied downstream from an IC voltage regulator(s). For example, they can be distributed for power transfer efficiency.

With embodiments disclosed herein, EPGs are used to dynamically control supply voltages provided to EPG domains, (typically associated with circuits for like functions). EPGs are able to respond quickly (e.g., switching within a few nanoseconds) to regulate power provided to circuits within a domain or EPG domain without adversely affecting neighboring EPG domains.

Not only can they provide On/Off (switch-level) control, but also, they can be extended to act as mini regulators on the die to lower the supply voltage to a region. As represented in the diagram of FIG. 1, the use of EPGs can result in significant (up to 95%) leakage power saving. Furthermore, in some embodiments such as with multi-core designs, they can allow for yield recovery, e.g., when there are core shorts.

FIG. 1 shows three power states—active 102, sleep 104, and shut-off 106—that can be implemented with different EPG configurations. It also shows the possible leakage savings that may be attained for each state. The active state is the nominal state of regular operation, where the EPGs are active and the logic is powered by a normal operational Vcc supply. EPG gates may be turned on to couple a Vcc supply to the EPG domain during this state.

The sleep state is obtained by switching the EPGs into a high resistance mode, thus driving logic into a retention state, i.e. keeping the voltage above the minimum value required to maintain logic state; the logic is not active and clocks are gated to save active power. to provide for this state, EPG gates may be coupled in parallel with fixed (configured to be on with a the chip or the like) gates having larger “on” impedances so that when the EPG gates are switched off, supply to the domain is reduced but not collapsed. Alternatively, they could be coupled to variable voltage regulators to provide different supply levels.

The shut-off state is set when the logic is not required to keep state and therefore, supplies in shut-off can be reduced to a minimum. In this mode, the EPG is disabled and the gated power supply is reduced, e.g., to about one tenth of its nominal value. During this time, leakage is at its minimum, for example, about ten times less than active mode.

Since a processor core is usually divided up into regional clocking areas, which are commonly referred to as regional clock buffer (RCB) domains, e.g., having dimensions of a few hundred microns per side, a EPG domain with an EPG can be thought of as an RCB region served by an EPG. RCB regions could also define clock-gated areas on the die. Nominally, a single RCB region is assumed to cover a Functional Unit Block (FUB) and to define a micro voltage EPG domain gated with an EPG.

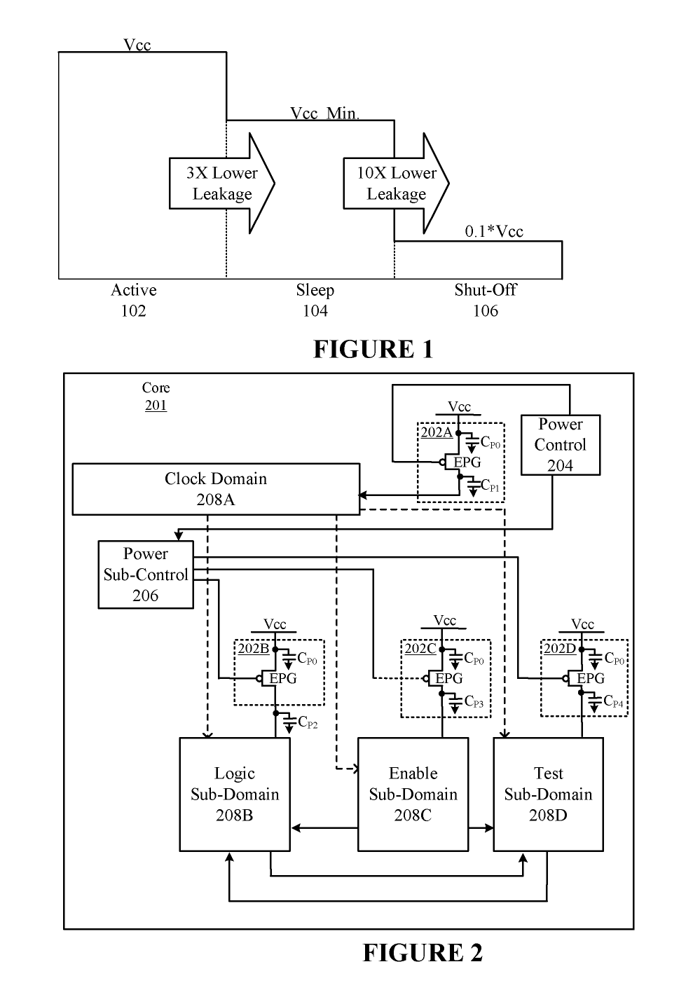

FIG. 2 shows a power distribution scheme with dynamic, independently controllable EPG domains 208, for a core 201 of a processor. The power distribution system comprises a power control block 204 and a power sub-control block 206 coupled to control embedded power gate circuits 202. The EPG circuits 202 comprise a multiple legs power gate transistor EPG.

The power control block 204 is coupled to the EPG circuit 202A to control power supplied to the clock EPG domain 208A. It also acts as a primary control block, controlling the power sub-control block 206, which oversees many of the functional EPG domains (logic 208B, enable 208C, test 208D) in the core. Accordingly, it is coupled to the depicted sub-control block 206 to enable/disable it and to provide administrative control, e.g., within the context of a global power management system such as with the Advanced Configuration and Power Interface (ACPI). It may also be coupled to other sub-control blocks for other cores on a chip.

With the depicted embodiment, a regulated supply (un-gated Vcc) enters the chip through power contacts (e.g., so-called C4 bumps with a flip-chip package). The ungated, regulated supply is gated through one or more relatively large EPG groups (not shown) and is distributed back to integrated logic by means of a gated Vcc power grid. For efficiency sake, the grid is implemented with a sufficiently thick layer in the die (e.g., M9 layer, which resistance is at least 10 times lower than that of the other metal die layers) so that the gated grid resistance is sufficiently small. In addition, the inductive paths from the package substrate capacitors to the ungated supply grids in the package should also be sufficiently small. Low resistance in the gated grid are mainly important from a DC point of view for current re-distribution. From an AC point of view, plated through hole (PTH) and effective series inductances (ESL) between the package capacitors and ungated package grid are of importance. In fact, in some embodiments, the inductance to the package substrate capacitors should be lower than the associated lateral inductance of the package to reduce detrimental droops and noise.

The EPG gates may be implemented with any suitable transistors (e.g., PMOS, NMOS, or the like) comprising multiple transistors coupled together in parallel. They may be any suitable size, depending, of course, on load requirements.

The decoupling capacitors may be implemented with any suitable technology that is capable of providing an EPG and its associated domain with sufficient capacitance and at the same time, have sufficiently small inductance paths (within a frequency range of interest) to the EPG and to the supply contacts. For example, 10 μF of package capacitance, close to the die, may be sufficient for an entire core, e.g., operating at 3 GHz.

The inductances (and resistances) of the charge/discharge paths, from the capacitors to the gated grids, should be suitably small so that the charge/discharge times are small enough to allow for fast on/off switching so that when sub domains are turned on or off, excessive current isn't leached away from or sinked into the capacitance of neighboring EPG domains and cause switching noise or droop problems. To achieve suitable capacitance with sufficiently small inductance/resistance paths, package level capacitors sufficiently close to the die with contacts sufficiently close to their respective transistors may be employed. An example of suitable package capacitors include embedded array capacitors (EACs) and thin film capacitors. Examples of suitable capacitors are disclosed in U.S. Pat. No. 6,936,498 to Survakumar et al. entitled “PACKAGE STRUCTURE WITH INCREASED CAPACITANCE AND METHOD,” which is hereby incorporated by reference into this disclosure.

With

the core portion of FIG. 2, the indicated EPG domains include a global clock EPG domain 208A, a logic EPG domain 208B, an enable EPG domain 208C, and test circuit EPG domain 208D. The EPG domains each comprise circuitry corresponding to their associated functionality. Each EPG domain 208 receives its supply power from a separate, associated EPG circuit 202, as depicted. The enable logic for the RCB is provided with a separate supply EPG domain 208C because, in some embodiments, it may be used to control both RCB and FUB logic for simple switch-level control. Similarly, the regional FUB-level test logic (also referred to as design-for-test, DFT) has its own EPG domain 208D with a separate EPG 202D to allow for a complete shut-down of most test structures and thus, additional power savings since the test structures only need to be powered up during production testing and can be powered down during normal operation in an operating system

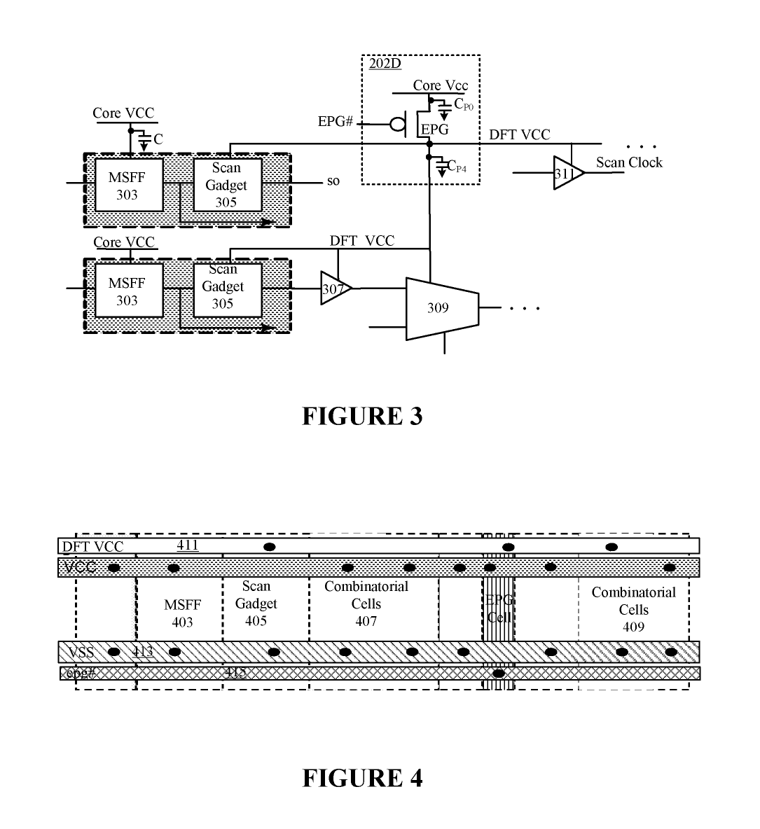

With reference to FIG. 3, an embodiment of a portion of a test circuit EPG domain is shown. Its EPG circuit 202D provides a separately controllable supply (DFT Vcc) for test circuit islands (305, 307, 309, 311), and thus, they can be placed into shut-off mode during normal operation (after testing), while other portions may be coupled to core Vcc. (Note that this concept applies to all EPG domains. That is, parts of them may be coupled to core Vcc, which may nor may not be gated, and other parts may be coupled to EPG circuits for partial supply reduction in an EPG domain.)

FIG. 4 shows how gated DFT supply 411 can be routed as a dedicated supply track in the power grid and shared by the DFT logic through a series of distributed EPGs (represented as dots in strip 411). Similarly, the EPGs control signal can be routed along a dedicated strip 415 and shared among DFT cells. Also in FIG. 1 the EPG is implemented as a standard place-and-route cell. Its placement can be automated using existing P&R tools.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The term “PMOS transistor” refers to a P-type metal oxide semiconductor field effect transistor. Likewise, “NMOS transistor” refers to an N-type metal oxide semiconductor field effect transistor. It should be appreciated that whenever the terms: “MOS transistor”, “NMOS transistor”, or “PMOS transistor” are used, unless otherwise expressly indicated or dictated by the nature of their use, they are being used in an exemplary manner. They encompass the different varieties of MOS devices including devices with different VTs, material types, insulator thicknesses, gate(s) configurations, to mention just a few. Moreover, unless specifically referred to as MOS or the like, the term transistor can include other suitable transistor types, e.g., junction-field-effect transistors, bipolar-junction transistors, metal semiconductor FETs, and various types of three dimensional transistors, MOS or otherwise, known today or not yet developed.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS., for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An apparatus, comprising:
a package substrate and a circuit die mounted to the package substrate, the circuit die comprising a processor with a core having a plurality of separate EPG domains,
the EPG domains each including an EPG circuit to provide a switchable supply to switchable domain circuitry, the EPG circuit comprising one or more embedded power gates having a supply node coupled to a supply and to at least one capacitor in the package, wherein the impedance from the capacitor to the supply node is sufficiently small to enable off and on switching of EPG domains in the FUB while it is operating.

2. The apparatus of claim 1, in which the EPG domain comprises circuitry including the switchable domain circuitry and non-switchable domain circuitry that is coupled to a separate supply not controlled by the EPG circuit.

3. The apparatus of claim 1, in which the capacitor includes an embedded array capacitor.

4. The apparatus of claim 1, in which the capacitor includes a thin film capacitor.

5. The apparatus of claim 1, in which the one or more embedded power gates are coupled in parallel to one or more fixed supply gates to provide a reduced supply when the one or embedded power gates are switched off.

6. The apparatus of claim 1, in which the one or more embedded power gates has a second node to provide the switchable supply to the switchable domain circuitry, the EPG circuit comprising at least one capacitor in the package coupled to the second node and being separate from the one or more capacitors coupled to the supply node.

7. The apparatus of claim 6, in which the one or more capacitors coupled to the second node includes an embedded array capacitor.

8. The apparatus of claim 6, in which the one or more capacitors coupled to the second node includes a thin film capacitor.

9. An apparatus, comprising:
a processor chip; and
a package substrate mounted to the chip, the processor chip comprising a core having a plurality of separate EPG domains,
the EPG domains each including an EPG circuit to provide a supply to at least a portion of the domain, the EPG circuit comprising one or more embedded power gates coupled to a supply and to at least one capacitor in the substrate, wherein the capacitor coupling to the one or more gates is sufficiently short to enable off and on switching of EPG domains while the core is operating.

10. The apparatus of claim 9, in which the EPG domains each comprise switchable and non-switchable domain circuitry that is coupled to a separate supply not controlled by the EPG circuit.

11. The apparatus of claim 9, in which the capacitor includes an embedded array capacitor.

12. The apparatus of claim 9, in which the capacitor includes a thin film capacitor.

13. The apparatus of claim 9, in which the one or more embedded power gates are coupled in parallel to one or more fixed supply gates to provide a reduced supply when the one or more embedded power gates are switched off.
